(19) United States
(12) Patent Application Publication
(10) Pub. No.: US 2012/0119950 A1
(43) Pub. Date: May 17, 2012

(54) NAVIGATION SATELLITE SIGNAL REPEATER AND NAVIGATION SATELLITE SIGNAL REPEATING METHOD

(75) Inventor: Daeho KIM, Daejeon (KR)

(73) Assignee: Electronics and Telecommunications Research Institute, Daejeon (KR)

(21) Appl. No.: 13/295,448

(22) Filed: Nov. 14, 2011

(30) Foreign Application Priority Data
Nov. 11, 2010 (KR) 10-2010-0112062

(51) Int. Cl. G01S 19/11

(52) U.S. Cl. 342/357.48

(57) ABSTRACT

A navigation satellite signal repeater and a navigation satellite signal repeating method are provided. The navigation satellite signal repeater includes an outdoor navigation satellite receiver and a plurality of navigation satellite signal generators. The outdoor navigation satellite receiver is configured to receive a navigation satellite signal from a navigation satellite and extract satellite information from the received navigation satellite signal. The navigation satellite signal generators are disposed in a building and are configured to receive the extracted satellite information through a transmission line, generate new satellite information in consideration of a time delay of the transmission line, and transmit a new navigation satellite signal corresponding to the new satellite information. The navigation satellite signal repeater repeats a new navigation satellite signal by reflecting a time delay of satellite information, thus enabling accurate location detection even in a poor environment (e.g., an indoor environment) where a navigation satellite signal is not received.

### CROSS-REFERENCE TO RELATED APPLICATIONS

This U.S. non-provisional patent application claims priority under 35 U.S.C. §119 of Korean Patent Application No. 10-2010-0112062, filed on Nov. 11, 2010, the entire contents of which are hereby incorporated by reference.

### BACKGROUND OF THE INVENTION

The present invention disclosed herein relates to a navigation satellite signal repeater and a navigation satellite signal repeating method.

In an environment where a navigation satellite signal is received, a navigation satellite is used to perform accurate location detection. In an environment where a navigation satellite signal is not received, a base station measures a location by triangulation by using a TX signal of a mobile station, or a mobile station measures a location by triangulation by using a TX signal of a base station. Also, in an assisted-GPS scheme, necessary satellite information is provided to a navigation satellite receiver terminal to reduce a location detection signal processing load. However, the above methods degrade the location detection accuracy and complicate the system.

### SUMMARY OF THE INVENTION

The present invention provides a navigation satellite signal repeater and a navigation satellite signal repeating method, which enable accurate location detection even in a poor environment (e.g., an indoor environment) where a navigation satellite signal is not received.

In some embodiments of the present invention, a navigation satellite signal repeater includes: an outdoor navigation satellite receiver configured to receive a navigation satellite signal from a navigation satellite and extract satellite information from the received navigation satellite signal; and a plurality of navigation satellite signal generators disposed in a building and configured to receive the extracted satellite information through a transmission line, generate new satellite information in consideration of a time delay of the transmission line, and transmit a new navigation satellite signal corresponding to the new satellite information.

In some embodiments, the satellite information includes navigation data, satellite ID (identification), and time information.

In other embodiments, each of the navigation satellite signal generators includes: a navigation satellite data generating unit configured to receive the extracted satellite information through the transmission line and generate new navigation data having time delay information of the transmission line; a navigation satellite spread signal generating unit configured to convert the new navigation data into a new navigation satellite signal; and a navigation satellite signal transmitting unit configured to transmit the new navigation satellite signal through a TX antenna.

In still further embodiments, the TX antenna includes three antennas.

In still further embodiments, the three antennas are disposed at angular intervals of 120°.

In still further embodiments, the TX antenna includes four antennas.

In still further embodiments, the four antennas are disposed at angular intervals of 90°.

In still further embodiments, the TX antenna includes at least three antennas configured to transmit the navigation satellite signal corresponding to at least three navigation satellites.

In still further embodiments, the navigation satellite signal repeater further includes a TX power controlling unit configured to generate a TX power control signal for controlling the TX power of the navigation satellite signal transmitting unit.

In other embodiments of the present invention, a navigation satellite signal repeating method includes: receiving a navigation satellite signal from an outdoor navigation satellite receiver; extracting satellite information from the received navigation satellite signal by the outdoor navigation satellite receiver; transmitting the extracted satellite information through a plurality of transmission lines to a plurality of navigation satellite signal generators, and generating new navigation satellite information by each of the navigation satellite signal generators by reflecting a time delay of the corresponding transmission line; and transmitting a new navigation satellite signal corresponding to the new navigation satellite information by each of the navigation satellite signal generators.

In some embodiments, the navigation satellite information reflecting the time delay is navigation data.

In other embodiments, the transmitting of the new navigation satellite signal includes transmitting the new navigation satellite signal through an antenna corresponding to satellite ID (identification) included in the satellite information.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram of a navigation satellite signal repeater according to an exemplary embodiment of the present invention;

FIG. 2 is a diagram illustrating an example of the time delays of navigation satellite signal generators illustrated in FIG. 1;

FIG. 3 is a diagram illustrating an example of a three-antenna TX antenna array illustrated in FIG. 1;

FIG. 4 is a diagram illustrating an example of a four-antenna TX antenna array illustrated in FIG. 1; and

FIG. 5 is a flow diagram illustrating a navigation satellite signal repeating method of a navigation satellite signal repeater according to an exemplary embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

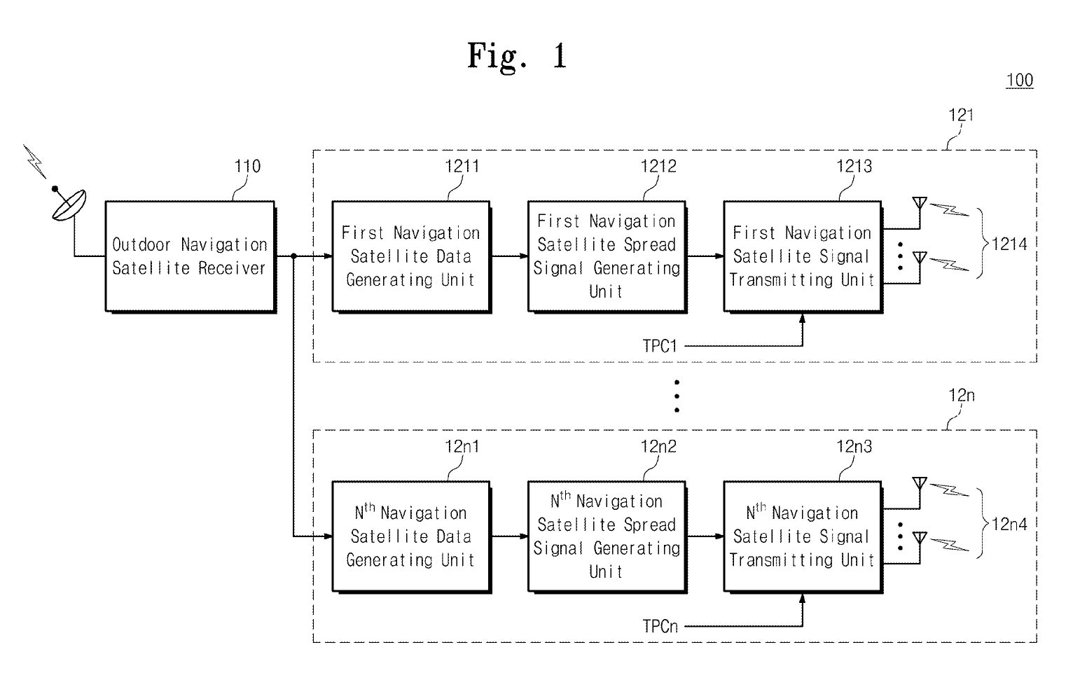

FIG. 1 is a block diagram of a navigation satellite signal repeater 100 according to an exemplary embodiment of the present invention.

Referring to FIG. 1, the navigation satellite signal repeater 100 includes an outdoor navigation satellite receiver 110 and a plurality of navigation satellite signal generators 121˜12n. Herein, n is an integer greater than 2.

The outdoor navigation satellite receiver 110 includes a satellite antenna, and receives a satellite signal from a navigation satellite through the satellite antenna. Herein, the satellite signal includes a time delay (Sd) between the navigation satellite and the outdoor navigation satellite receiver 110. The outdoor navigation satellite receiver 110 detects satellite information including navigation data, satellite ID (identification), and time information from the received satellite signal and outputs the detected information.

The outdoor navigation satellite receiver 110 may be installed in an outdoor place such as the outside of a building and the rooftop of a building, to receive a satellite signal.

Navigation satellite signals must be received from three satellites for navigation satellite-based two-dimensional location (latitude, longitude), and navigation satellite signals must be received from four satellites for navigation satellite-based three-dimensional location (latitude, longitude, altitude). In the existing GPS navigation satellite system, four satellites are always present in the upper air everywhere on earth, thus enabling high-accuracy location. Therefore, the outdoor navigation satellite receiver 110 must receive navigation satellite signals from at least three satellites.

Each of the navigation satellite signal generators 121˜12n is disposed in the building, and is connected through a transmission line to the outdoor navigation satellite receiver 110. Each of the navigation satellite signal generators 121˜12n receives satellite information including navigation data, satellite ID and time information from the outdoor navigation satellite receiver 110, and generates a navigation satellite signal on the basis of the received satellite information. The navigation satellite signal may be transmitted from up to four indoor TX antennas.

The navigation satellite signal generators 121˜12n have different time delays Td1˜Tdn until receiving the satellite information from the outdoor navigation satellite receiver 110. Hereinafter, a description will be given of the first navigation satellite signal generator 121 among the navigation satellite signal generators 121˜12n.

The first navigation satellite signal generator 121 includes a first navigation satellite data generating unit 1211, a first navigation satellite spread signal generating unit 1212, a first navigation satellite signal transmitting unit 1213, and a first TX antenna 1214.

The first navigation satellite data generating unit 1211 extracts the navigation data from the satellite information received from the outdoor navigation satellite receiver 110, and generates new navigation data having a time delay Td1 with respect to the transmission line of the first navigation satellite data generating unit 1211.

The first navigation satellite spread signal generating unit 1212 converts the new navigation data, outputted from the first navigation satellite data generating unit 1211, into an analog navigation satellite signal.

The first navigation satellite signal transmitting unit 1213 transmits the navigation satellite signal, received from the first navigation satellite spread signal generating unit 1212, through the first TX antenna 1214. Herein, the TX antenna includes three or four antennas.

The first navigation satellite signal transmitting unit 1213 may control TX power in response to a first TX power control signal TPC1. Herein, although not illustrated in FIG. 1, the first TX power control signal TPC1 may be generated by a TX power controlling unit.

The navigation satellite signal transmitted through the TX antenna includes time delay (Td1) information corresponding to the first navigation satellite signal generator 121. Accordingly, a satellite terminal (not illustrated) receiving the navigation satellite signal can detect the accurate location of the first navigation satellite signal generator 121 from the time delay (Td1) information.

A typical navigation satellite signal repeater cannot reflect a time delay of a transmission line when repeating a navigation satellite signal. Thus, it is impossible to perform accurate location detection in a poor environment (e.g., an indoor environment) where a navigation satellite signal is not received.

On the other hand, the navigation satellite signal repeater 100 according to an exemplary embodiment of the present invention adds and transmits the time delay information when repeating the navigation satellite signal received from the outdoor navigation satellite signal receiver 110, thereby making it possible to detect the accurate location of the navigation satellite signal generator from the navigation satellite signal.

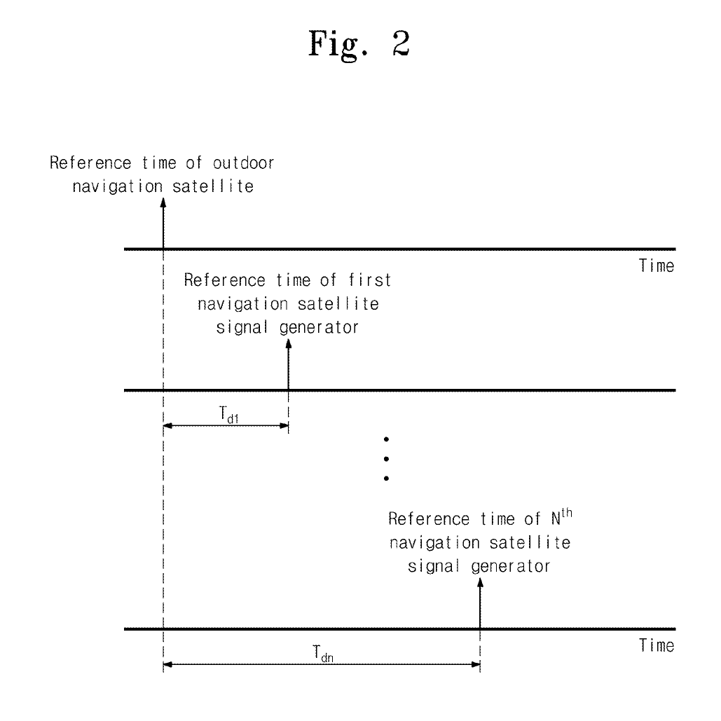

FIG. 2 is a diagram illustrating an example of the time delays of the navigation satellite signal generators 121˜12n illustrated in FIG. 1.

Referring to FIG. 2, with respect to the reference time to receive the satellite signal from the outdoor navigation satellite receiver 110 of FIG. 1, the first navigation satellite signal generator 121 has a first time delay Td1 and the n^{th} navigation satellite signal generator 12n has an n^{th} time delay Tdn. Herein, the navigation satellite signal generators 121˜12n may be disposed on the respective floors of the building.

If the navigation satellite signal generators 121˜12n are disposed on the respective floors of the building, the time delays correlate with the respective floors of the building. For example, the navigation satellite signal generator disposed on the floor near to the rooftop of the building has a small time delay, and the navigation satellite signal generator disposed on the floor distant from the rooftop of the building has a large time delay.

Each of the navigation satellite signal generators 121˜12n generates and transmits the new navigation satellite signal on the basis of the satellite information, the navigation data, the satellite ID and the time information. Herein, if one TX antenna is used, because the signal sources of navigation satellite signals are identical to each other, a navigation satellite receiver (not illustrated) can obtain only distance information about a TX antenna. Therefore, in an exemplary embodiment, each of the navigation satellite signal generators 121˜12n includes at least three antennas as a TX antenna array.

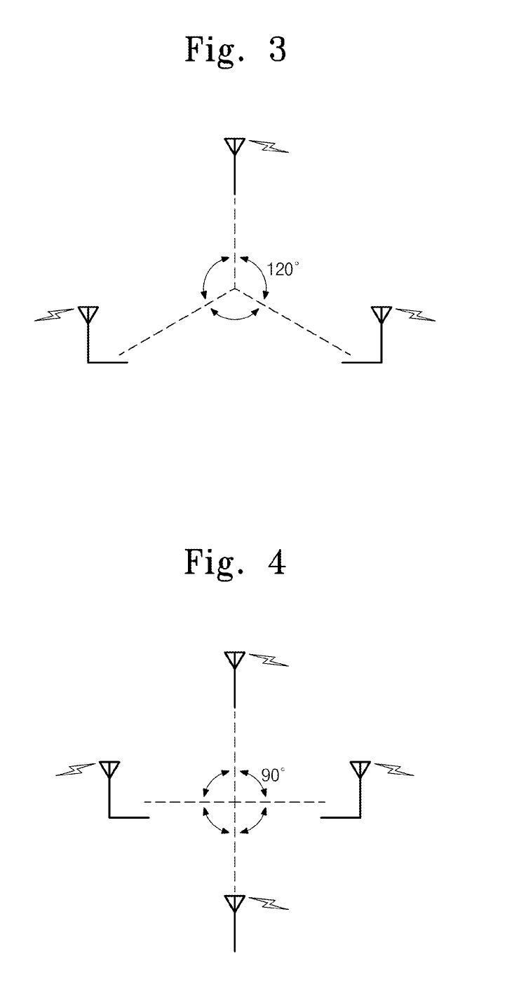

FIG. 3 is a diagram illustrating an example of a three-antenna TX antenna array illustrated in FIG. 1.

Referring to FIG. 3, three antennas are disposed at angular intervals of 120°.

FIG. 4 is a diagram illustrating an example of a four-antenna TX antenna array illustrated in FIG. 1.

Referring to FIG. 4, four antennas are disposed at angular intervals of 90°.

FIGS. 3 and 4 illustrate examples of the TX antenna array. The actual TX antenna array may be modified according to the surrounding conditions.

The navigation satellite signal repeater 100 according to an exemplary embodiment of the present invention generates a TX signal for each satellite ID and transmits the TX signal through a TX antenna corresponding to each satellite ID as illustrated in FIGS. 3 and 4. Thus, it is possible to solve the problem that the signal sources of navigation satellite signals become identical to each other. Accordingly, a navigation satellite terminal in the building can perform location detection in an indoor place.

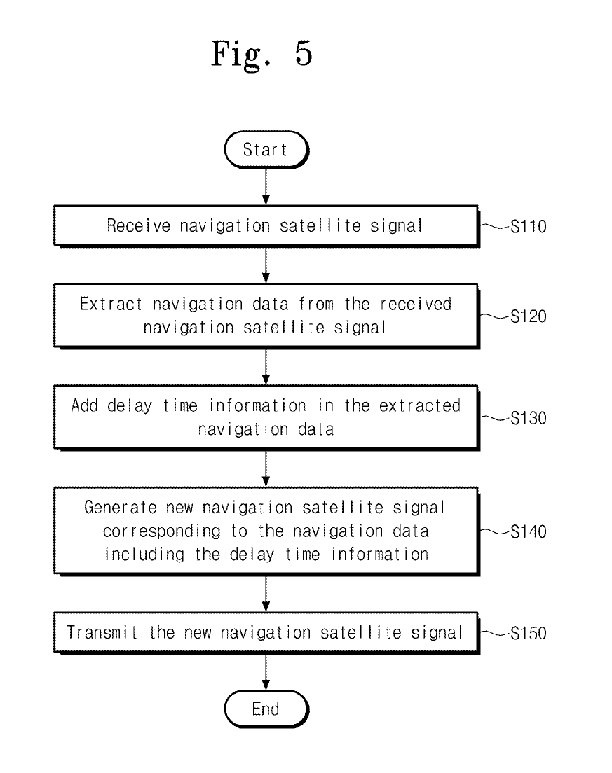

FIG. 5 is a flow diagram illustrating a navigation satellite signal repeating method of the navigation satellite signal repeater 100 according to an exemplary embodiment of the present invention.

Referring to FIGS. 1 and 5, the outdoor navigation satellite signal receiver 110 receives a navigation satellite signal from at least one navigation satellite (S110). The outdoor navigation satellite signal receiver 110 extracts satellite information including navigation data, satellite ID, and time information from the received navigation satellite signal (S120).

The extracted satellite information is transmitted through the corresponding transmission lines to the navigation satellite signal generators 121˜12n. Each of the navigation satellite data generating units 1211˜12n1 of the navigation satellite signal generators 121˜12n generates new navigation data by adding time delay information corresponding to the navigation data (S130).

Each of the navigation satellite spread signal generating units 1212˜12n2 of the navigation satellite signal generators 121˜12n generates a new navigation satellite signal corresponding to the new navigation data (S140).

The navigation satellite signal transmitting units 1213˜12n3 of the navigation satellite signal generators 121˜12n transmit the new navigation satellite signal through the corresponding TX antennas 1214˜12n4 (S150).

As described above, the navigation satellite signal repeater and the navigation satellite signal repeating method according to the present invention repeats a new navigation satellite signal by reflecting a time delay of satellite information, thus enabling accurate location detection even in a poor environment (e.g., an indoor environment) where a navigation satellite signal is not received.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A navigation satellite signal repeater comprising:
an outdoor navigation satellite receiver configured to receive a navigation satellite signal from a navigation satellite and extract satellite information from the received navigation satellite signal; and
a plurality of navigation satellite signal generators disposed in a building and configured to receive the extracted satellite information through a transmission line, generate new satellite information in consideration of a time delay of the transmission line, and transmit a new navigation satellite signal corresponding to the generated new satellite information.

2. The navigation satellite signal repeater of claim 1, wherein the satellite information includes navigation data, satellite ID (identification), and time information.

3. The navigation satellite signal repeater of claim 2, wherein each of the navigation satellite signal generators comprises:
a navigation satellite data generating unit configured to receive the extracted satellite information through the transmission line and generate new navigation data having time delay information of the transmission line;
a navigation satellite spread signal generating unit configured to convert the generated new navigation data into an new navigation satellite signal; and
a navigation satellite signal transmitting unit configured to transmit the new navigation satellite signal through a TX antenna.

4. The navigation satellite signal repeater of claim 3, wherein the TX antenna comprises three antennas.

5. The navigation satellite signal repeater of claim 4, wherein the three antennas are disposed at angular intervals of 120°.

6. The navigation satellite signal repeater of claim 3, wherein the TX antenna comprises four antennas.

7. The navigation satellite signal repeater of claim 6, wherein the four antennas are disposed at angular intervals of 90°.

8. The navigation satellite signal repeater of claim 3, wherein the TX antenna comprises at least three antennas configured to transmit the navigation satellite signal corresponding to at least three navigation satellites.

9. The navigation satellite signal repeater of claim 3, further comprising a TX power controlling unit configured to generate a TX power control signal for controlling the TX power of the navigation satellite signal transmitting unit.

10. A navigation satellite signal repeating method comprising:
receiving a navigation satellite signal from an outdoor navigation satellite receiver;
extracting satellite information from the received navigation satellite signal by the outdoor navigation satellite receiver;
transmitting the extracted satellite information through a plurality of transmission lines to a plurality of navigation satellite signal generators, and generating new navigation satellite information by each of the navigation satellite signal generators by reflecting a time delay of the corresponding transmission line; and
transmitting a new navigation satellite signal corresponding to the new navigation satellite information by each of the navigation satellite signal generators.

11. The navigation satellite signal repeating method of claim 10, wherein the navigation satellite information reflecting the time delay is navigation data.

12. The navigation satellite signal repeating method of claim 10, wherein the transmitting of the new navigation satellite signal comprises transmitting the new navigation satellite signal through an antenna corresponding to satellite ID (identification) included in the satellite information.
